(19) United States
(12) Patent Application Publication
(10) Pub. No.: US 2022/0385628 A1
(43) Pub. Date: Dec. 1, 2022

(54) MONITORING LIVENESS OF SILENT HOSTS' IP ADDRESSES FROM A LAYER 2 VIRTUAL TUNNEL ENDPOINT IN AN ETHERNET VIRTUAL PRIVATE NETWORK USING PROBES

(71) Applicant: Arista Networks, Inc., Santa Clara, CA (US)

(72) Inventors: Kallol Mandal, Sausalito, CA (US); May Louie, Burnaby (CA); Karthikeyan Kathiresan, Bengaluru, Karnataka (IN); Alton Lo, Fremont, CA (US)

(21) Appl. No.: 17/884,042

(22) Filed: Aug. 9, 2022

(30) Foreign Application Priority Data
Jun. 14, 2022 (IN) 202241033912

(51) Int. Cl. H04L 61/58; H04L 61/103

(52) U.S. Cl. CPC H04L 61/58; H04L 61/103

(57) ABSTRACT

Embodiments of the disclosure include a method comprising storing a first identifier of a first host device in an Address Resolution Protocol (ARP) cache of a first VXLAN Tunnel Endpoint (VTEP); making a first determination that an age of the first identifier exceeds a defined age threshold; sending, as a result of the first determination, a first request to the first host device to confirm liveness of the first identifier; and removing the first identifier from the ARP cache as a result of failing to receive a first response from the first host device within a defined time period.

### BACKGROUND

The present application relates to computer networks and, more particularly, to address management in a network device.

In previous solutions, a VTEP may learn an ARP/ND entry from bridged ARP/ND traffic via an L2 EVPN Top of Rack switch (TOR switch). The ARP/ND entry is removed from the L2 ARP cache in response to an associated media access control (MAC) address being removed from the MAC address table of the TOR switch. The MAC addresses for “silent” hosts may expire on the L2 TOR switches that learned them on the front-panel as a result of the silent hosts not generating traffic satisfying certain criteria. Some traffic may be lost as a result of sending routed traffic to silent hosts and the missing ARP/ND entries will need to be relearned from a Layer 3 TOR.

### BRIEF DESCRIPTION OF THE DRAWINGS

With respect to the discussion to follow and in particular to the drawings, it is stressed that the particulars shown represent examples for purposes of illustrative discussion and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 illustrates a network topology including a plurality of network architectures communicatively coupled via a network tunnel according to one or more embodiments.

FIG. 2 illustrates an example physical network structure included in the network topology 100 of FIG. 1 according to one or more embodiments.

FIG. 3 shows a network environment 300 in which a network device implements a plurality of data structures according to one or more embodiments.

FIG. 4 illustrates a method 400 for handling MAC identifier table updates according to one or more embodiments.

FIG. 5A illustrates an example of probe generation according to an embodiment.

FIG. 5B illustrates the steps taken for process 500B.

FIG. 6 illustrates the steps for handling an ARP/ND response.

FIG. 7A illustrates the process for pending L2 ARP/ND deletions.

FIG. 7B illustrates a portion of the process in FIG. 7A.

FIG. 10 illustrates a network device that is adapted to operate according to one or more embodiments.

### DETAILED DESCRIPTION

### Overview

The present disclosure provides techniques for maintaining liveness of identifiers associated with a network. In the following description, for purposes of explanation, numerous examples and specific details are set forth to provide a thorough understanding of the present disclosure. It will be evident, however, to one skilled in the art that the present disclosure as expressed in the claims may include some or all of the features in these examples, alone or in combination with other features described below, and may further include modifications and equivalents of the features and concepts described herein.

The present disclosure is directed to maintaining liveness of an Internet Protocol (IP) address associated with an Ethernet Virtual Private Network (EVPN) by a Layer 2 (L2) Virtual Extensible Local Area Network (VXLAN) Tunnel Endpoint (VTEP). A first VTEP and a second VTEP connected by a VXLAN tunnel are each communicatively coupled to one or more hosts (e.g., laptops, servers, mobile devices). The first VTEP and the second VTEP each store a set of Address Resolution Protocol (ARP) or Neighbor Discovery (ND) entries in an ARP cache.

The present disclosure implements a refresh mechanism for ARP and/or ND entries in the L2 ARP cache of an L2 EVPN TOR switch, which is a first VTEP of the EVPN. An ARP/ND entry (e.g., MAC/IP address) for a first host connected to the first VTEP is stored in the L2 ARP cache. As a result of the ARP/ND entry (e.g., MAC address) expiring, the first VTEP attempts to refresh the ARP/ND entry. The first VTEP sends a request to the first host to confirm liveness of the ARP/ND entry. If the first VTEP receives a response from the first host confirming liveness of the ARP/ND entry within a defined time period, the first VTEP will maintain the ARP/ND entry in the ARP cache. If the first VTEP fails to receive the response within the defined time period, the first VTEP deletes the ARP/ND entry from the ARP cache.

The first VTEP that has not learned the MAC/IP binding of the first host may receive requests from other VTEPs of the EVPN to provide identifying information regarding hosts associated with the first VTEP. For instance, a second VTEP may receive, from a second host on the same VLAN as the first host and that is communicatively coupled to the second VTEP, a first request to provide an identifier of the first host. The second VTEP may send a second request to the first VTEP over the VXLAN to provide the identifier. To resolve the second request, the first VTEP obtains the first identifier of the first host from the ARP cache and publishes the MAC/IP binding of the first host to the second VTEP via the EVPN.

The first VTEP may also discover and store identifying information regarding other hosts in the EVPN. The second VTEP, for instance, may learn a second identifier of the second host and broadcast the second identifier to the first VTEP and other VTEPs in the EVPN. The first VTEP stores the second identifier in a second table of the ARP cache. The second table may be a table of remote ARP/ND bindings. In response to receiving a request from the first host to provide an identifier of the second host on the same VLAN as the first host, the first VTEP may obtain the second identifier from the table of remote ARP/ND bindings instead of sending a request to the second VTEP to provide the identifying information.

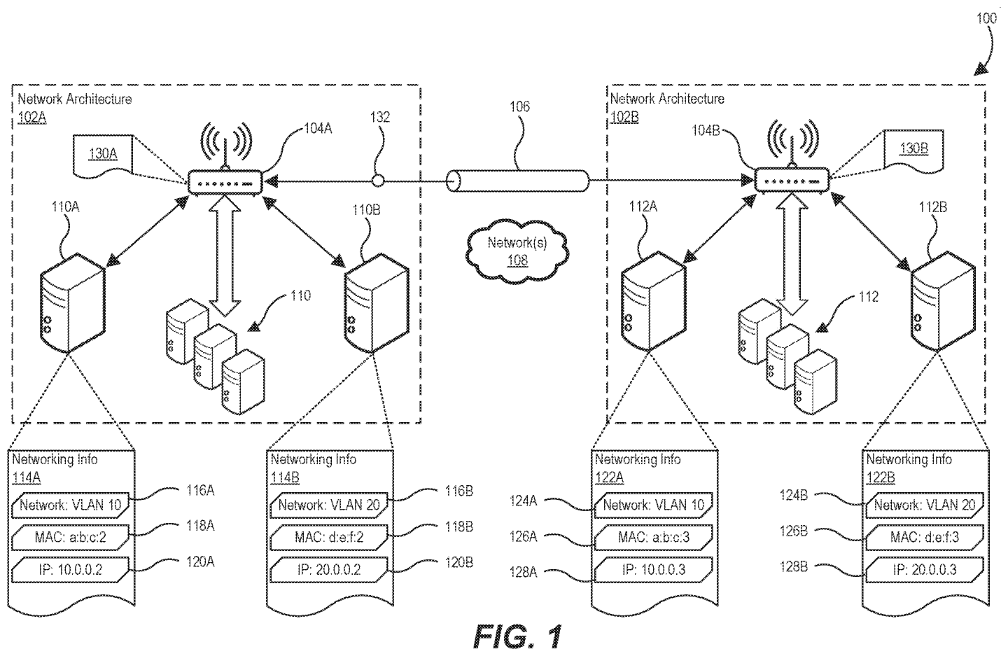

FIG. 1 illustrates a network topology 100 including a plurality of network architectures communicatively coupled via a network tunnel according to one or more embodiments. The network topology 100 includes a first network architecture 102A having a first network device 104A and includes a second network architecture 102B having a second network device 104B. The first network device 104A is communicatively coupled to the second network device 104B via a network tunnel 106 over one or more networks 108.

The first network device 104A is communicatively coupled to a host device 110A and a host device 110E in the network architecture 102A. The second network device 104B is communicatively coupled to a host device 112A and a host device 112B in the network architecture 102B. The host devices 110A and 110E may be included among a plurality of host devices 110 in the network architecture 102A to which the first network device 104A is communicatively coupled. The host devices 112A and 112B may be included among a plurality of host devices 112 in the network architecture 102B to which the second network device 104B is communicatively coupled. The first and second network devices 104A and 104B are configured to mediate communications between one or more of the host devices 110 and one or more of the host devices 112 via the network tunnel 106.

The first and second network devices 104A and 104B (collectively “network devices 104”) are Virtual Tunnel Endpoints (VTEPs) of the network tunnel 106. In some embodiments, the first and second network devices 104A and 104B are Layer 2 VTEPs. In some embodiments, the first and second network devices 104A and 104B do not have Switched Virtual Interfaces (SVIs) configured. However, those skilled in the art understand that the same techniques may be implemented in a system containing any number of host devices and/or L2 VTEPs that are configured to provide one or more Virtual Local Area Networks (VLAN). For example, each VLAN may be a VLAN configured according to a Virtual Extensible Local Area Network (VXLAN) Virtual Extensible LAN protocol. In such embodiments, an individual VLAN may have a virtual network identifier (VNI).

The network tunnel 106 is, in some embodiments, a Virtual Extensible Local Area Network (VXLAN) tunnel established and maintained according to the VXLAN protocol. In some embodiments, the one or more networks 108 include an Ethernet Virtual Private Network (EVPN) through which the network tunnel 106 is established. In such embodiments, the network tunnel 106 may be established in an EVPN underlay network. The techniques described herein may be used in other network configurations that use VPNs, virtual private LAN services (VPLSs), and other similar technologies.

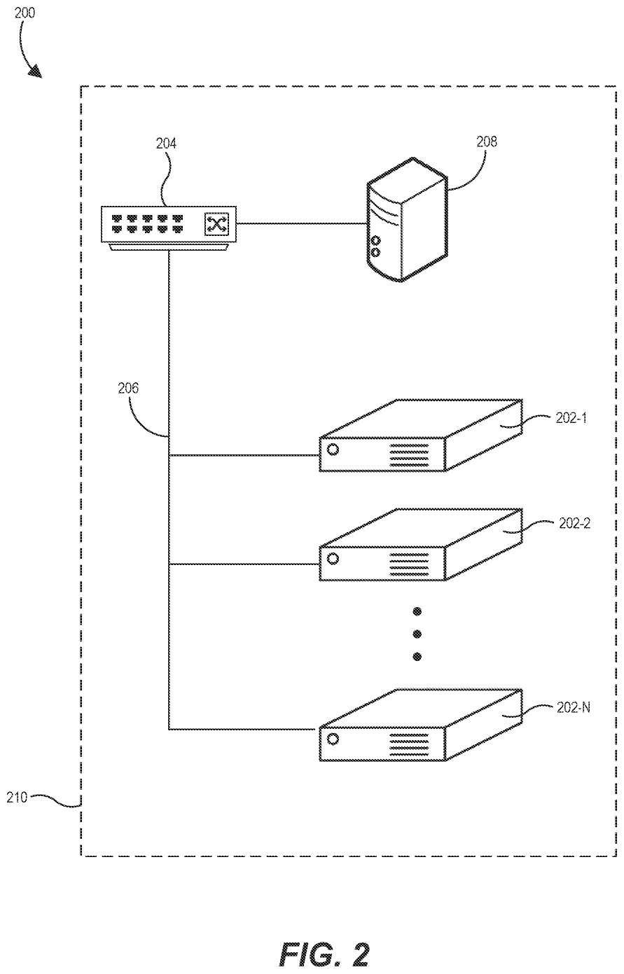

In some embodiments, the network architecture 102A and/or the network architecture 102B are physical structures in which the network devices 104A and 104B and the host devices 110 and 112 are respectively located. The network architectures 102 may correspond, for example, to a rack, a cabinet, or other such structure in which network devices, host devices, and interconnection devices and equipment may be installed. The network architecture 102A and the network architecture 102B may be disposed in different locations. For instance, the network architecture 102A may be located in a first data center whereas the network architecture 102B may be located in a second data center different than the first data center. The different locations in which the network architectures 102A and 102B are located may be different buildings, different campuses, and/or different geographical regions (e.g., different cities, different states, different countries, different continents). In some embodiments, the network architectures 102A and 102B may have a particular design, such as a Top-of-Rack (ToR) design in which the network device 104 is located in the rack or cabinet and all of the host devices in the rack or cabinet are connected (e.g., via cabling) to the network device 104. Further description of this architecture is described with respect to FIG. 2 infra.

At least some of the host devices of the network architectures 102A and 102B store networking information associated with communications between host devices. The host devices 110A and 110B respectively store network information 114A and 114B that is useable to communicate with one or more of the host devices 112 of the network architecture 102B. The network information 114A includes a network identifier 116A, a MAC identifier 118A, and an IP identifier 120A; and the network information 114B includes a network identifier 116B, a MAC identifier 118B, and an IP identifier 120B. The host devices 112A and 112B respectively store network information 122A and 122B that is useable to communicate with one or more of the host devices 110 of the network architecture 102A. The network information 122A includes a network identifier 124A, a MAC identifier 126A, and an IP identifier 128A; and the network information 122B includes a network identifier 124B, a MAC identifier 126B, and an IP identifier 128B.

In this particular non-limiting example, the host device 110A and the host device 112A are on a first VLAN. Accordingly, the network identifier 116A in the network information 114A matches the network identifier 124A of the network information 122A. The host device 110E and the host device 112B are on a second VLAN different than the first VLAN. Accordingly, the network identifier 116B in the network information 114B matches the network identifier 124B of the network information 122B. Also, in this particular non-limiting example, the network devices 104A and 104B are configured with an L2 ARP proxy feature disabled.

Because the network devices 104 are L2 VTEPs with no SVIs, they do not learn ARP or ND entries or store an ARP/ND table. Therefore, the network devices 104 do not publish local ARP bindings or Neighbor bindings to the EVPN. As a result, the network devices 104 do not proxy reply on behalf of the network devices 110 and/or 112 to ARP requests or ND requests for remote hosts received from local hosts.

The network devices 104A and 104B may store at least some of the networking information 114 and 122, respectively, in memory thereof. More particularly, the network devices 104A and 104B may respectively store one or more data structures 130A and 130B in memory (e.g., volatile memory) having entries indicating associations between IP identifiers and MAC identifiers of the host devices 110 and 112. The data structure(s) 130A may include a mapping between the MAC identifier 118A and the IP identifier 120A of the host device 110A and a mapping between the MAC identifier 118B and the IP identifier 120B of the host device 110B. The data structure(s) 130B may include a mapping between the MAC identifier 126A and the IP identifier 128A of the host device 112A and a mapping between the MAC identifier 126B and the IP identifier 128B of the host device 112B. The data structures 130A and 130B may each include an ARP table or cache and/or an ND table or ND cache.

The network devices 104 use the mappings in the data structures 130 to determine a host device corresponding to a destination identifier in a data packet received. The network device 104A, for instance, may receive a data packet 132 sent to one of the host devices 110 over the network tunnel 106 by the network device 104B. The network device 104A may process the data packet 132 (e.g., decapsulate the data packet 132) and obtain a destination IP identifier for the data packet 132—the IP identifier 10.0.0.2 in this particular example. The network device 104A may refer to the data structure 130A and determine that the destination IP identifier 10.0.0.2 corresponds to the MAC identifier a:b:c:2. As a result of resolving the destination IP identifier of the data packet 132, the network device 104A sends the data packet 132 to the host device 110A having the MAC identifier a:b:c:2.

The network devices 104 are configured with an aging mechanism in which an inactivity time for each stored MAC identifier is monitored and the MAC identifiers may be removed from the data structures 130 as a result of the inactivity time meeting or exceeding a defined aging threshold. For example, the network device 130A may store the MAC identifier 118A of the host device 110A in the data structure 130A. As a result of not receiving network traffic from or addressed to the host device 110A for a period of time exceeding a defined aging threshold (e.g., 30 seconds), the network device 130A removes an entry from the data structure 130A mapping the MAC identifier 118A with the IP identifier 120A.

Removal of MAC identifier mappings from the data structures 130 can cause inefficiencies in network traffic. Subsequent to removal of a mapping between the MAC identifier 118A and the IP identifier 120A from the data structure 130A, the network device 104A may receive a request from the network device 104A to provide network information that includes mappings between MAC identifiers and IP identifiers. As a result of removing the mapping, however, the network device 104A may request at least some of the networking information 114 from the host devices 110 before responding to the request from the network device 104B. The additional request to the host devices 110 and response from the host device 110A prolongs the time involved, increases network bandwidth utilization in the network architecture 102A, and temporarily increases resources utilized by the host devices 110 for the network device 104A to successfully provision the network information requested. If the host device 110A does not respond in a given time period to the request for network information 114A, the request to the network device 104A may be unfulfilled.

The embodiments disclosed herein provide an additional opportunity to refresh the mapping between IP identifiers and MAC identifiers before the mapping is removed from the data structure(s) 130. As a result, the network devices 104 may provide a quick response to other network devices 104 in the EVPN with information identifying local hosts. Moreover, the network devices 104 are able to respond to requests for identifying information from other network devices 104 in the EVPN without additional requests to the local hosts, thereby reducing the network bandwidth utilized to fulfill such requests. Refreshment of identifiers of different hosts associated with the network devices 104 is performed asynchronously to prevent a spike in network traffic.

FIG. 2 illustrates an example physical network structure 200 included in the network topology 100 of FIG. 1 according to one or more embodiments. The physical network structure 200 is a Top-of-Rack (TOR) design in which a plurality of host devices 202-1, 202-2, . . . 202-N (collectively “host devices 202”) are physically communicatively coupled with a set of network devices 204 via network cabling 206. With reference to FIG. 1, the set of network devices 204 correspond to the network devices 104 and the host devices 202 correspond to the host devices 110 and 112. In some embodiments, the physical network structure 200 may include a network controller 208 for configuring and/or controlling operation of the set of network switches 204.

The set of network devices 204 include one or more network switches, such as Ethernet switches, aggregation switches, and fiber optic switches, by way of non-limiting example. The network cabling 206 may include Ethernet cables, copper wiring, fiber optic cables, and other similar communication mediums for conveying network data.

The physical network structure 200 includes a housing 210 containing the set of network switches 204, the plurality of host devices 202, and, in some embodiments, the network controller 208. The housing 210 also contains at least a portion of the network cabling 206. In some embodiments, some of the network cabling 206 may be routed on an external surface or portion of the housing 210 between internal components of the housing 210. The housing 210 may be a rack, a chassis, or other physical structure configured to house and support the set of network switches 204 and the plurality of host devices 202. The physical network structure 200 may include other devices or components not shown in some embodiments.

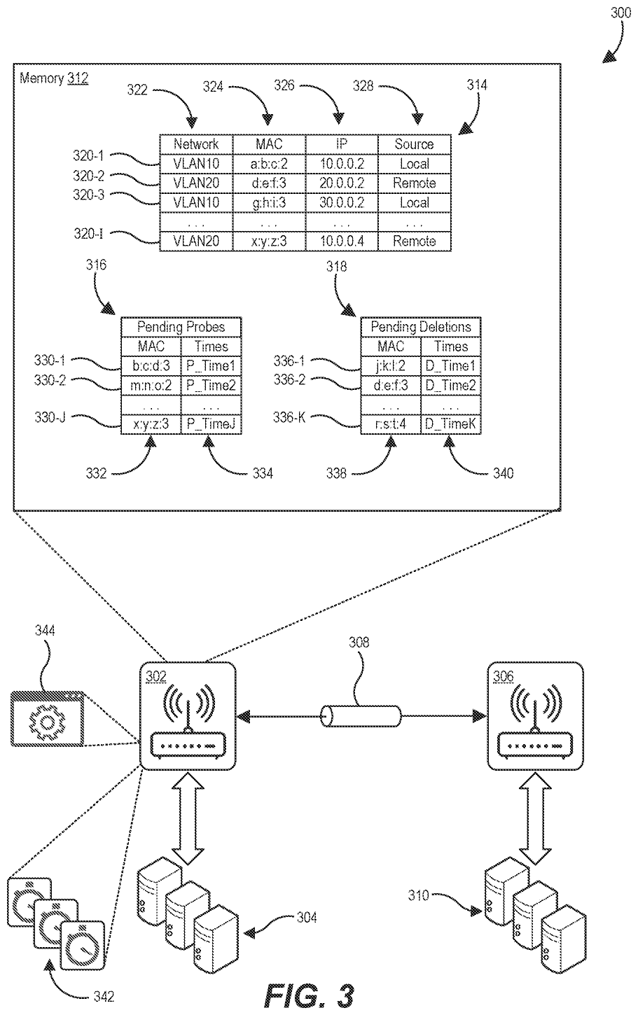

FIG. 3 shows a network environment 300 in which a network device implements a plurality of data structures according to one or more embodiments. The network environment 300 includes several features that are substantially similar to those described with respect to FIGS. 1, 2, and elsewhere herein so further description thereof is omitted for brevity. The network environment 300 includes a network device 302 communicatively coupled with a plurality of host devices 304 as described with respect to FIG. 2 and elsewhere herein. The network environment 300 also includes a network device 306 communicatively coupled with the network device 302 via a network tunnel 308. The network device 306 is communicatively coupled with a plurality of host devices 310 as described with respect to FIG. 2 and elsewhere herein. In some embodiments, the network devices 302 and 306 are L2 VTEPs of a network, such as an EVPN.

The network device 302 includes memory 312 storing a plurality of data structures containing information associated with at least some of the host devices 304. More particularly, the memory 312 stores a bridging table 314 that includes entries regarding bridged bindings between MAC identifiers and IP identifiers associated with the host devices 304. The memory 312 also stores a pending probes list 316 including entries regarding pending probes to be issued to a set of the host devices 304. The memory 312 further stores a pending deletion list 318 including entries regarding bindings and/or MAC identifiers that are to be deleted from the bridging table 314.

The bridging table 314 is a data structure, such as a table or array that stores ARP bindings and/or ND bindings between the MAC identifiers and the IP identifiers of the host devices 304. The bridging table 314 includes sets of entries 320-1, 320-2, 320-3, . . . 320-I (collectively “sets of entries 320”) that are each associated with one of the host devices 304. Each of the sets of entries 320 includes a network identifier 322, a MAC identifier 324, an IP identifier 326, and a source indicator 328 associated with one of the host devices 304. The source indicator 328 entries indicate whether the associated binding was learned locally by the network device 302 or learned from another VTEP via an EVPN. For instance, the network device 302 may remotely learn bindings associated with one or more of the host devices 310 via communications with the network device 306.

The pending probes list 316 is a data structure, such as a table, list, or array that stores a collection of MAC identifiers associated with L2 ARP bindings or L2 ND bindings that are pending for initiation of a refresh probe. The pending probes list 316 includes one or more sets of entries 330-1, 330-2, . . . 330-J (collectively “sets of entries 330”) that are each associated with one of the host devices 304 or one of the host devices 310. Each of the sets of entries 330 include a MAC identifier 332 of the associated host device. Each of the set of entries 330 may include or be associated with a probe time 334, as described in greater detail below.

The pending deletion list 318 is a data structure, such as a table, list, or array that stores a collection of MAC identifiers associated with L2 ARP bindings or L2 ND bindings that are pending for deletion from the bridging table 314. The pending deletion list 318 includes one or more sets of entries 336-1, 336-2, . . . 336-K (collectively “sets of entries 336”) that are each associated with one of the host devices 304 or one of the host devices 310. Each of the sets of entries 336 include a MAC identifier 338 of the associated host device. Each of the set of entries 336 may include or be associated with a deletion time 340, as described in greater detail below.

The network device 302 is configured to initiate and monitor a plurality of timer tasks 342 to be associated with entries in the bridging table 314, the pending probes list 316, and/or the pending deletion list 318. The network device 302 implements an asynchronous event-based model for tracking MAC aging using the timer tasks 342. More specifically, the network device 302 tracks the age of each of the entries 320 in the bridging table 314. As a result of the age of an entry of the entries 320 exceeding a defined age value, the network device 302 adds removes the entry from the bridging table 314. In response to removal of an entry from the bridging table 314, the network device 302 probes the corresponding host device to determine whether the host device is still active and present on the network. In other implementations, the network device 302 may implement a synchronous timer-based model in which the network device 302 proactively sends probes before the entry reaches a defined age.

In some cases, a synchronous timer-based model may creates inefficiencies and increases computing resources. For instance, the number of “silent hosts,” which are host devices that are active but do not send network traffic, are significantly fewer than the number of active hosts considering the amount of bridged network traffic in a network. Moreover, designing a proactive polling that refreshes all hosts may be inefficient. The asynchronous model described herein, which accounts for silent hosts, may be a more optimal solution in some cases, and can reduce computing resource usage because data packets are generated upon the occurrence of the triggering event (e.g., MAC aging).

The network device 302, in some embodiments, implements one or more agents 344 that are configured to perform the various operations described herein. The one or more software agents 344 are collections of logic, such as computer programs, executing on the network device 302 to perform operations described herein. The one or more agents 344 may operate in parallel with other computer programs executing on the network device 302.

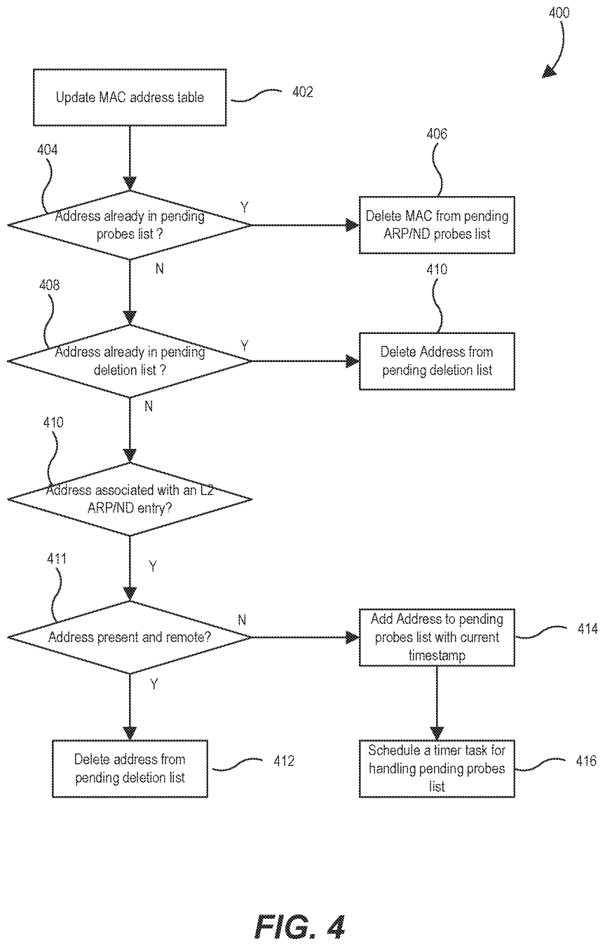

FIG. 4 illustrates a method 400 for handling MAC identifier table updates according to one or more embodiments. The method 400 may be performed by a network device described herein, such as the network device 302. Some or all of the method 400 may be performed by a software agent 344 executing on a processing unit of the network device 302. Various features of the method 400 reference features described with respect to FIGS. 1, 2, 3, and elsewhere herein.

The method 400 includes updating, at 402, a MAC address table. Updating the MAC address table in 402 may include adding one or more entries 320 to the bridging table 314. The network device 302 may add an entry 320 to the bridging table 314 as a result of sending a request to a host device (e.g., host devices 304) or a remote network device (e.g., network device 306) for confirmation of liveness and receiving a response confirming that the host device is still active on the network.

The method 400 includes determining, at 404, whether any MAC identifier entry in the bridging table 314 is in the second data structure

At 406, the MAC is deleted from the pending ARP/ND probes list.

At 408, the system determines if the MAC is already in the pending L2 APR/ND deletion list. If yes, then the MAC is deleted from the pending L2 ARP/ND deletion list at 410.

If no, then the system determines if the MAC is associated with an L2 ARP/ND entry. If yes, then the system determines if the MAC is present and remote. If yes, then the MAC is deleted from table. If no, then the MAC is added to the pending ARP/ND probe list with a current time stamp and a timer task is scheduled for handling pending ARP/NP probes list.

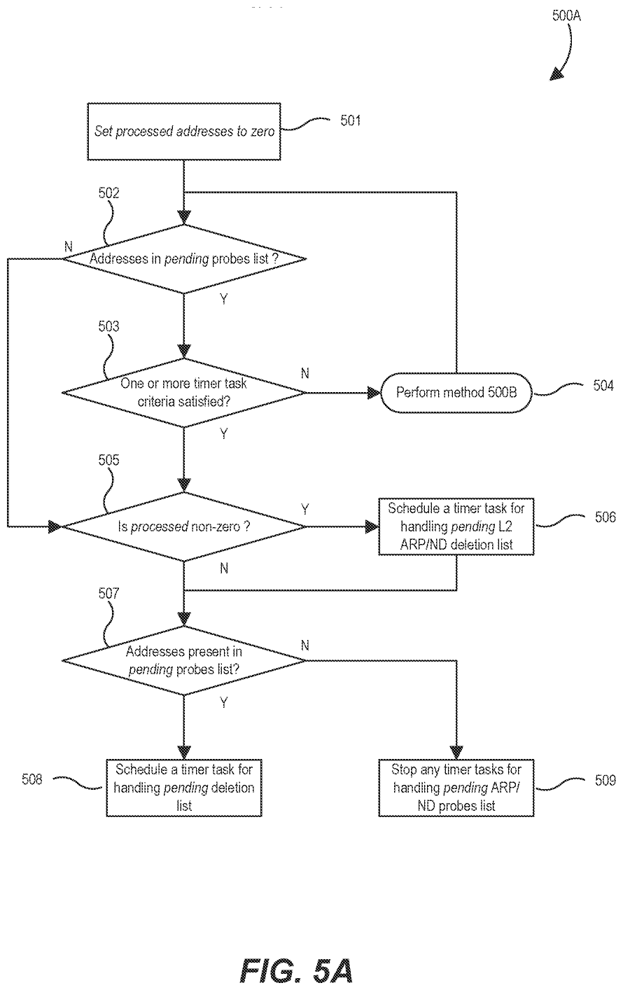

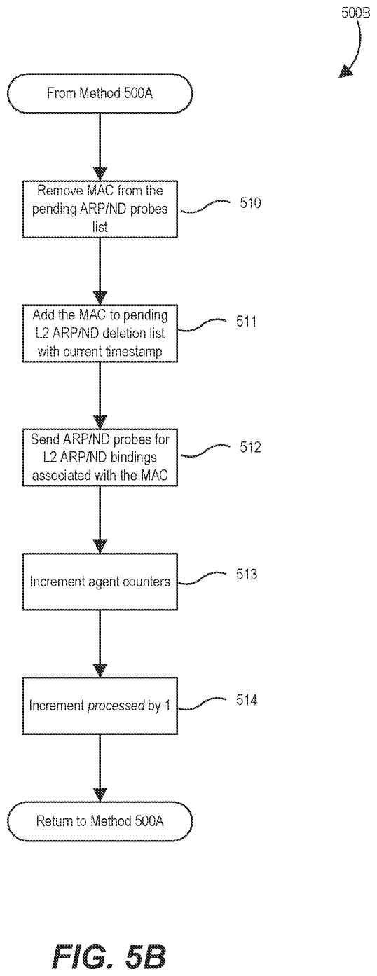

FIG. 5A illustrates an example of probe generation according to an embodiment.

At 501 the processed addresses is set to zero.

At 502, the system determines if there are MACs in the pending ARP/ND probes list. If yes, then the system determines time task criteria at 503 (e.g., should time task yield (or) is the number of probes sent greater than a maximum probes allowed in one time task?). If no, then the system moves to step 505.

If the system determine the task criteria are not satisfied, then the system performs the process 500B. If the system determine the task criteria are satisfied, then the system moves to step 505.

At 505, the system determines if the processed address are non-zero. If yes, then the system schedules a timer task for handling pending L2 ARP/ND deletion list at 506. If no, then the system moves to step 507.

At 507, the system determines if there are MACs in pending ARP/ND. If yes, then the system schedules a timer task for handling pending ARP/NC probes in the deletion list. If no, then the system moves to step 509.

At 509, the system stops any timer tasks for handling pending ARP/ND probes list.

FIG. 5B illustrates the steps taken for process 500B.

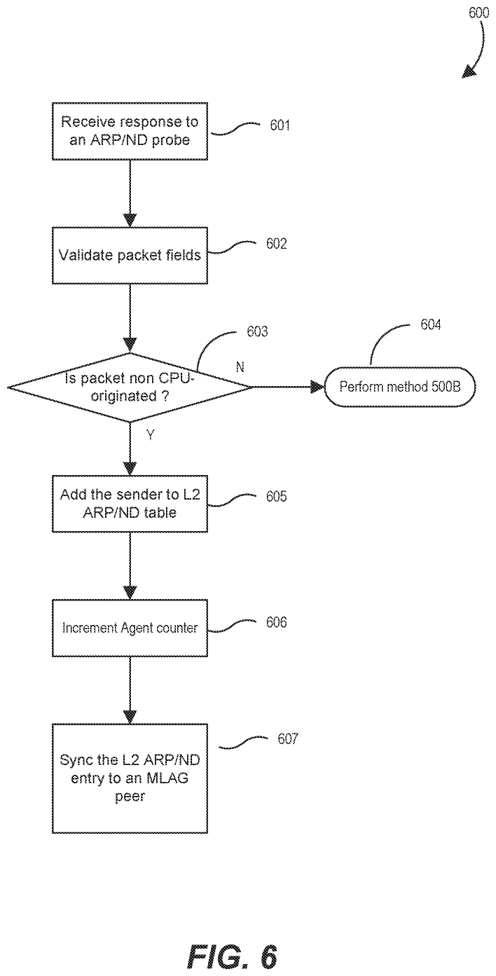

FIG. 6 illustrates the steps for handling an ARP/ND response.

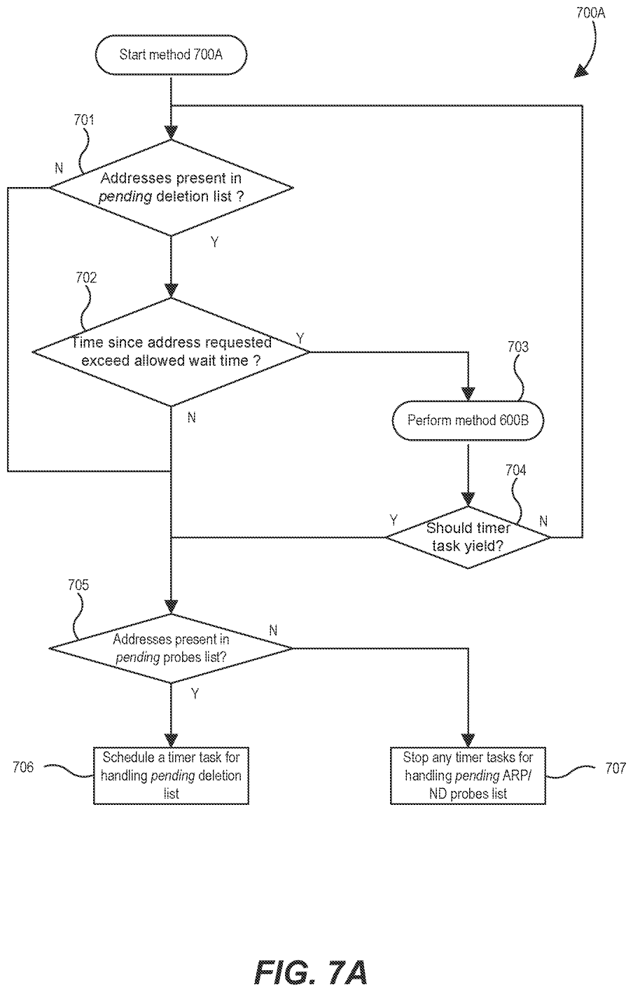

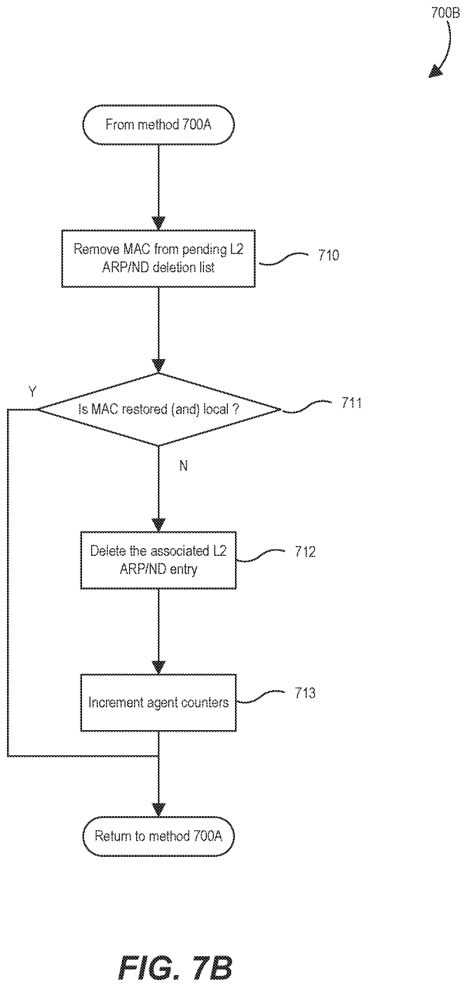

FIG. 7A illustrates the process for pending L2 ARP/ND deletions.

FIG. 7B illustrates a portion of the process in FIG. 7A.

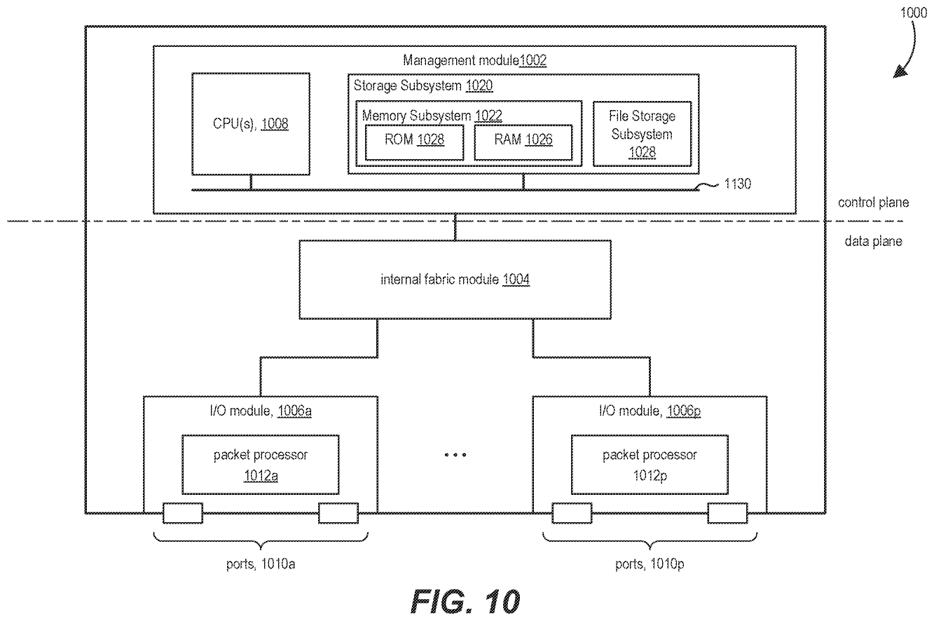

FIG. 10 illustrates a network device 1000 that is adapted to operate according to one or more embodiments of the present disclosure. The network device 1000 may be a switch or a router, for example. As shown, network device 1000 can include a management module 1002, an internal fabric module 1004, and a number of I/O modules 1006a-1006p. The management module 1002 may be disposed in a control plane (also referred to as control layer) of the network device 1000 and can include one or more management CPUs 1008 for managing and controlling operation of network device 1000 in accordance with the present disclosure. Each management CPU 1008 can be a general-purpose processor, such as an Intel®/AMD® x86-64 or ARM® processor, that operates under the control of software stored in memory, such as a storage subsystem 1020, which may include read-only memory 1028 and/or random-access memory 1026. In some embodiments, the CPU 1008 may include control circuitry, and may include or be coupled to a non-transitory storage medium storing encoded instructions that cause the CPU 1008 to perform operations described herein. In some embodiments, the non-transitory storage medium may include encoded logic or hardwired logic for controlling operation of the CPU 1008. The control plane refers to all the functions and processes that determine which path to use, such as routing protocols, spanning tree, and the like.

Internal fabric module 1004 and I/O modules 1006a-1006p collectively represent the data plane of network device 1000 (also referred to as data layer, forwarding plane, etc.). Internal fabric module 1004 is configured to interconnect the various other modules of network device 1000. Each I/O module 1006a-1006p includes one or more input/output ports 1010a-1010p that are used by network device 1000 to send and receive network packets. Each I/O module 1006a-1006p can also include a packet processor 1012a-1012p. Each packet processor 1012a-1012p can comprise a forwarding hardware component configured to make wire speed decisions on how to handle incoming (ingress) and outgoing (egress) network packets. In some embodiments, the forwarding hardware can comprise an application specific integrated circuit (ASIC), a field programmable array (FPGA), a digital processing unit, or other such collection of configured logic.

### Further Embodiments

Embodiments herein include a method, network device, system, and/or computer readable medium comprising: storing a first identifier of a first host device in an Address Resolution Protocol (ARP) cache of a first VXLAN Tunnel Endpoint (VTEP); making a first determination that an age of the first identifier exceeds a defined age threshold; sending, as a result of the first determination, a first request to the first host device to confirm liveness of the first identifier; and removing the first identifier from the ARP cache as a result of failing to receive a first response from the first host device within a defined time period.

In one embodiment, method, network device, system, and/or computer readable medium further comprising: storing a second identifier of a second host device in the ARP cache; making a second determination that an age of the second identifier exceeds the defined age threshold; sending, as a result of the second determination, a second request to the second host device to confirm liveness of the second identifier; receiving a second response from the second host device confirming liveness of the second identifier; and preserving storage of the second identifier in the ARP cache as a result of receiving the second response.

In one embodiment, the method, network device, system, and/or computer readable medium further comprising: receiving, prior to removing the first identifier, a request from a second VTEP to provide the first identifier of the first host device; obtaining the first identifier from the ARP cache; and sending a response to the second VTEP including the first identifier.

In one embodiment, the first VTEP is a VTEP of a Ethernet Virtual Private Network (EVPN).

In one embodiment, the method, network device, system, and/or computer readable medium further comprising: receiving, from a second VTEP over the EVPN, a second identifier of a second host device associated with the second VTEP; storing the second identifier in the ARP cache; receiving a request from the first host device to provide an identifier of the second host device; obtaining the second identifier from the ARP cache; and sending the second identifier to the first host device in fulfillment of the request.

In one embodiment, the method, network device, system, and/or computer readable medium further comprising: storing a second identifier of a second host device in the ARP cache; making a second determination that an age of the second identifier exceeds the defined age threshold, wherein the second determination is asynchronous to the first determination.

1. A method comprising:
storing a first identifier of a first host device in an Address Resolution Protocol (ARP) cache of a first VXLAN Tunnel Endpoint (VTEP);
making a first determination that an age of the first identifier exceeds a defined age threshold;
sending, as a result of the first determination, a first request to the first host device to confirm liveness of the first identifier; and
removing the first identifier from the ARP cache as a result of failing to receive a first response from the first host device within a defined time period.

2. The method of claim 1, comprising:
storing a second identifier of a second host device in the ARP cache;
making a second determination that an age of the second identifier exceeds the defined age threshold;
sending, as a result of the second determination, a second request to the second host device to confirm liveness of the second identifier;
receiving a second response from the second host device confirming liveness of the second identifier; and
preserving storage of the second identifier in the ARP cache as a result of receiving the second response.

3. The method of claim 1, comprising:
receiving, prior to removing the first identifier, a request from a second VTEP to provide the first identifier of the first host device;
obtaining the first identifier from the ARP cache; and
sending a response to the second VTEP including the first identifier.

4. The method of claim 1, wherein the first VTEP is a VTEP of a Ethernet Virtual Private Network (EVPN).

5. The method of claim 1, comprising:
receiving, from a second VTEP over the EVPN, a second identifier of a second host device associated with the second VTEP;
storing the second identifier in the ARP cache;
receiving a request from the first host device to provide an identifier of the second host device;
obtaining the second identifier from the ARP cache; and
sending the second identifier to the first host device in fulfillment of the request.

6. The method of claim 1 comprising:
storing a second identifier of a second host device in the ARP cache;
making a second determination that an age of the second identifier exceeds the defined age threshold, wherein the second determination is asynchronous to the first determination.

7. A network device storing program code that, as a result of execution by a processor in the network device, causes the network device to perform the method of claim 1.

8. A non-transitory computer readable medium storing program code that, when executed by a processor, causes the processor to perform the method of claim 1.
